(19) United States
(12) Patent Application Publication
(10) Pub. No.: US 2024/0182376 A1
(43) Pub. Date: Jun. 6, 2024

(54) METHOD FOR CONTINUOUSLY PELLETIZING WATER-SOLUBLE SOLIDS

(71) Applicant: LIMITED LIABILITY COMPANY "GSM CHEMICAL", Moscow (RU)

(72) Inventor: Vladislav Mikhailovich GENKIN, Moscow (RU)

(21) Appl. No.: 18/553,428

(22) PCT Filed: Mar. 23, 2022
(86) PCT No.: PCT/RU2022/000088

§ 371 Date: Sep. 29, 2023

(30) Foreign Application Priority Data
Apr. 1, 2021 (RU) 2021108925

(51) Int. Cl. C05C 3/00; C05G 5/14

(52) U.S. Cl. CPC C05C 3/005; C05G 5/14

(57) ABSTRACT

The present invention relates to a field of chemical engineering and in particular to a method for continuously pelletizing water-soluble solids, comprising steps of: a) feeding raw material and seed particles to a pelletizing disc; b) pelletizing water-soluble solids during wetting with an aqueous phase; c) removing pelletized product from the pelletizing disc; d) drying the pelletized product from step c); e) dividing the dried pelletized product from step d) into fractions; e) removing the commercial fraction from the process, characterized in that in step e), the dried pelletized product from step d) is divided into four fractions: a commercial fraction having a pellet diameter in the range of D₁ to D₂; a coarse fraction having a pellet diameter>D₂; a recycled fraction having a pellet diameter in the range of

$$\frac{{D}_{1} + {D}_{2}}{9}$$

to D₁; and a fine fraction having a pellet diameter in the range of

$$< \frac{{D}_{1} + {D}_{2}}{9} ;$$

wherein the recycled fraction is fed as the seed particles to the raw material feeding step a), the coarse fraction is fed for grinding to a particle diameter in the range of

$$\frac{{D}_{1} + {D}_{2}}{9}$$

to D₁ and then recycled to the process at the raw material feeding step a), the fine fraction is fed for grinding until there are no pellets having the size exceeding the particle size of the raw material, and also recycled to the raw material feeding step a), wherein the raw material particle diameter is

$$< \frac{{D}_{1} + {D}_{2}}{44} .$$

The invention relates to the field of chemical engineering and, in particular, to a method for continuously pelletizing water-soluble solids, comprising the steps of: a) feeding raw material and seed particles to a pelletizing disc; b) pelletizing water-soluble solids during wetting with an aqueous phase; c) removing pelletized product from the pelletizing disc; d) drying the pelletized product from step c); e) dividing the dried pelletized product from step d) into fractions; e) removing the commercial fraction from the process, characterized in that in step e), the dried pelletized product from step d) is divided into four fractions: a commercial fraction having a pellet diameter in the range of D₁ to D₂; a coarse fraction having a pellet diameter>D₂; recycled fraction having a pellet diameter in the range of

$$\frac{{D}_{1} + {D}_{2}}{9}$$

to D₁; and a fine fraction having a pellet diameter in the range of

$$< \frac{{D}_{1} + {D}_{2}}{9} ;$$

wherein the recycled fraction is fed as the seed particles to the raw material feeding step a), the coarse fraction is fed for grinding to a particle diameter in the range of

$$\frac{{D}_{1} + {D}_{2}}{9}$$

to D₁ and then recycled to the process at the raw material feeding step a), the fine fraction is fed for grinding until there are no pellets having the size exceeding the particle size of the raw material, and also recycled to the raw material feeding step a), wherein the raw material particle diameter is

$$< \frac{{D}_{1} + {D}_{2}}{44} .$$

In addition to solving standard chemical problems, the production of bulk chemical products, is also inherently associated with the need to impart the properties, which are most in demand for the consumer, to the end product. The recent trend is that consumers give preference to pelletized bulk products with a clearly controlled particle size distribution, since they consider this as a significant simplification of further process steps, as well as obtaining economic advantages associated with logistics and storage. Therefore, the development of pelletizing technology for bulk chemical products is gaining increasing interest from manufacturers.

One of the areas most interested in the development of technology for producing pelletized products is agriculture, since the pelletizing step is often decisive in the process of producing mineral fertilizers. Because powdered fertilizers, especially hygroscopic ones, have poor flowability and are dispersed very unevenly due to the sticking of small crystals. Furthermore, they can cake and harden heavily, requiring a lot of labor to re-grind them. Fertilizer pelletizing is the most effective method of reducing caking and improving the dispersion of fertilizers. Regardless of the improvement in physical properties, pelletizing can significantly increase the agrochemical value of fertilizers, especially water-soluble phosphates. Moreover, pelletized fertilizers make it possible to create nutritionally balanced complex fertilizer mixtures before applying them to agricultural crops in order to obtain the planned quantity and quality of products.

Currently, the development of pelletizing for bulk chemical products is aimed at reducing production costs, increasing productivity and improving the quality of the resulting products, in particular, obtaining the end product, so-called “commercial fraction”, with a given particle size distribution and the highest possible yield.

The standard pelletizing process for bulk products comprises the step of layering the liquid phase and/or wet solid phase on the surface of the so-called recycled product comprising small particles of a certain size, the drying and/or cooling step to stabilize the pellet structure, the step of classifying the pelletized charge and dividing pellets of the required size (commercial fraction), the step of crushing the coarse fraction and recycling the resulting fine fraction in the form of a recycled product to the pelletizer.

In the pelletizing process, usually at the pelletizer outlet, the pellets have a fairly wide size distribution, wherein pellets having the required size range form the “commercial fraction”, pellets having the sizes exceeding the required ones form the “coarse fraction”, and pellets having small sizes form the “fine fraction”

The pelletizing process is very unstable and subject to the influence of many factors, from the performance of the equipment to the composition and humidity of the raw materials, which can lead to both wave-like fluctuations in the ratio of the amount of commercial fraction to coarse and fine fractions, and to a complete stop of the process due to the lack of commercial fraction.

In this regard, an important problem is the need in providing the ability to control the particle size distribution in order to obtain a pelletized product that is stable both in size and in physicochemical properties.

Several approaches are known from the prior art to control the pelletizing process.

For example, when producing pelletized ammonium phosphate, to control the pelletizing mode, the authors of RU Patent No. 2455228 propose selecting certain process indicators, in particular, to carry out two-step pelletizing, while controlling the moisture content of the pulp.

RU Patent No. 2450854 discloses the method for producing pelletized ammonium phosphates, wherein the pelletizing process is controlled by changing the density of the recycled product curtain at the pulp spraying and charge balling steps and the charge residence time at these steps.

RU Patent No. 2631073 discloses a method for producing pelletized wood ash, which consists of balling the pelletized particles with the simultaneous feeding the powder and liquid components and further drying of the pellets, while screenings of wood ash with a particle size of up to 1.5 mm are used as pelletized particles, balling is carried out in a disc pelletizer, the liquid component is water, and dry wood ash with a bulk weight of 560-600 kg/m³ is used as a powder component. The control of the particle size distribution is carried out by changing the angle of inclination of the pelletizing disc, its rotation speed, as well as the water to ash ratio in the range of 0.27 to 0.29.

The above methods give a positive effect and make it possible to obtain the required pelletized product only if the described process parameters are strictly observed. However, in large-scale production, inevitable disruptions occur in the technological process associated with incoming raw materials and equipment operation. In order to adjust the particle size distribution of the end product, it is necessary to change the process parameters.

Another approach to control the pelletizing process is also known in the prior art, as in U.S. Pat. No. 4,501,773, concerning embodiments of a continuous pelletizing method, comprising: (a) spraying drops of a liquid, sticky, hardening substance into a gas stream; (b) passing said gas stream comprising said droplets through solid seed particles in the pelletizer (c), and obtaining enlarged seed particles at the pelletizer outlet (d), to control the particle size distribution of the end product, it is proposed to divide the particles obtained after pelletizing into three fractions comprising (i) a end pelletized product having a particle size range within the desired particle size range, (ii) a finer pelletized product having a particle size range below the desired particle size range, and (iii) a coarser pelletized product having a particle size range over the desired particle size range. The end pelletized product is then discharged. The finer powdered or pelletized product (fraction A) is transferred to the first tank for storage. The coarser pelletized product is transferred to a second tank for storage. A portion of the coarser pelletized product stored in the second tank is removed and crushed so that the average particle size becomes smaller than the average particle size of fraction A. These particles are then recycled to the pelletizer, and the particle size distribution of the end charge is controlled by changing the first and second tank flow ratio.

The disadvantage of this method is that the said control is used only if the process deviates from the specified parameters by constant automated analysis of the effluent product, and a special algorithm is used to shift the ratio of particles fed as the recycled product from the first and second tanks, and the authors themselves note that that a wave-like fluctuation in the composition is possible if the shift in the ratio of the recycled particles is not completed timely. Thus, the method comprises a very complex control system that requires constant monitoring, both by the automation and maintenance personnel.

The closest prior art of the claimed invention is RU Patent No. 2545328 C1, which discloses a method for controlling the process for pelletizing phosphorus-containing fertilizers, comprising the step of dividing the pelletized charge into fine, commercial and coarse fractions with grinding of the coarse fraction and recycling the fine fraction, crushed coarse fraction and part of the commercial fraction to process, wherein a part of the recycled commercial fraction is divided into two streams, one of which is subjected to grinding, and this stream is taken in the amount required to obtain a charge with a given equivalent particle diameter. However, the disadvantage of this method is the use of part of the commercial fraction as the recycled product, which significantly reduces the yield of the end product and, furthermore, it is necessary to constantly monitor the process due to the occurring changes in the particle size distribution, which, if not completed in a timely manner, can lead to a shift in the ratio of the recycled particles to wave-like composition fluctuations.

Thus, the objective of the present invention was to provide a method for continuously pelletizing water-soluble solids, which would be stable without the need to adjust the production parameters during the pelletizing process, would not require recycling a portion of the commercial fraction but would produce a product with a constant particle size distribution and with almost quantitative yield, in terms of the input starting component.

This problem was solved by means of a method for continuously pelletizing water-soluble solids, comprising the steps of:
a) feeding raw material and seed particles to a pelletizing disc;
b) pelletizing water-soluble solids during wetting with an aqueous phase;
c) removing pelletized product from the pelletizing disc;
d) drying the pelletized product from step c);
e) dividing the dried pelletized product from step d) into fractions;
f) removing the commercial fraction from the process;
characterized in that at step e) the dried pelletized product from step d) is divided into four fractions:
commercial fraction having a pellet diameter in the range of D₁ to D₂;
coarse fraction having a pellet diameter of >D₂;
recycled fraction having a pellet diameter in the range of

$$\frac{{D}_{1} + {D}_{2}}{9}$$

### to D₁;

fine fraction having a pellet diameter of

$$< \frac{{D}_{1} + {D}_{2}}{9} ;$$

characterized in that the recycled fraction is fed as seed particles to the raw material feeding step a), the coarse fraction is fed for grinding to a particle diameter in the range of

$$\frac{{D}_{1} + {D}_{2}}{9}$$

to D₁ and then recycled to the process at raw material feeding step a), the fine fraction is fed for grinding until there are no pellets having the size exceeding that of the raw material, and also recycled to turned to raw material feeding step a), and the raw material particle diameter is

$$< \frac{{D}_{1} + {D}_{2}}{44} .$$

The proposed method for continuously pelletizing water-soluble solids makes it possible to stabilize the pelletizing process without the need for constant adjustment of the production process parameters, does not require recycling a part of the commercial fraction by using a coarse fraction to replenish the recycled product, and provides a end product with a particle size distribution that does not change over time, while guaranteeing a substantially quantitative yield, in terms of the input starting component, and therefore increases the economic profitability and pelletizing process accessibility, especially for industrial scale production of water-soluble solids.

Our method according to the invention was based on the idea that, in the process of pelletizing solids, only particles having a significantly smaller size than the size of the recycled particles can stick to the recycled particles, and in the case of particles that are close in size to the recycled particles, no such sticking occurs.

On this basis, in our opinion, in the case of a continuous pelletizing process, where a part of the pelletized charge is constantly recycled to the process, the pelletized product circulation circuit continuously more and more particles in the increases, which are slightly smaller than the recycled particles, and sticking does not occur to the proper extent, this affects the distribution of particles in the pelletizer, which in turn leads to a change in the particle size distribution and a decrease in the amount of the desired commercial fraction. To stabilize the process, the plant operator tries to change the process parameters (such as the aqueous phase feeding rate, pelletizing disc inclination, rotation speed, etc.); in the first period, this leads to a leveling of the situation, however, the number of particles, which are slightly smaller than the recycled particles, still increases, and the process again leaves the required particle size distribution, which again requires a change in process parameters. Thus, continuously arising wave-like vibrations should be leveled by the operator or automated control system.

Based on this idea, when recycling the fine fraction to the pelletizer, we proposed to remove particles with sizes slightly smaller than the recycled particles from the pelletized product circulation circuit. In particular, if we operate with the desired range of the commercial fraction, which is denoted as the pellet diameter in the range of D₁ to D₂, then the particle size (diameter) of the recycled fraction is in the range of

$$\frac{{D}_{1} + {D}_{2}}{9}$$

to D₁ and therefore it is necessary to remove particles with sizes of

$$\frac{{D}_{1} + {D}_{2}}{9}$$

to

$$\frac{{D}_{1} + {D}_{2}}{44}$$

from the fine fraction having the pellet diameter of

$$< \frac{{D}_{1} + {D}_{2}}{9} .$$

This removal is carried out by grinding the fraction of

$$< \frac{{D}_{1} + {D}_{2}}{9}$$

until there is a complete absence of pellets having the size exceeds that of the starting raw material, i.e. up to particle diameter of

$$< \frac{{D}_{1} + {D}_{2}}{44} .$$

Furthermore, in order to further reduce the fraction content of

$$\frac{{D}_{1} + {D}_{2}}{9}$$

to

$$\frac{{D}_{1} + {D}_{2}}{44}$$

in the pelletizer, the raw material may be classified before entering the pelletizer and selected particles having a size of

$$> \frac{{D}_{1} + {D}_{2}}{44}$$

may be subjected to grinding together with the recycled fine fraction.

Thus, the technical effect of the present invention is the absence of accumulation in the pelletized product circulation circuit of the particles that do not participate in the process of forming pellets from the recycled fraction particles but interfere with the establishment of stable conditions for the formation of the desired particle size distribution, which makes it possible to reduce the load on the equipment used in the method and to direct production resources at maximum to the product as well as increase the yield of the end product.

According to the invention, any solid materials that, when wetted with the aqueous phase in a pelletizer, are suitable for agglomeration and balling and can be used as water-soluble solids in the method.

In a preferred embodiment of the method according to the invention, the water-soluble solids are mineral salts.

In a particularly preferred embodiment of the method according to the invention, the water-soluble solids are sodium, potassium or ammonium nitrates, sulfates or chlorides.

In the most preferred embodiment of the method according to the invention, the water-soluble solid is ammonium sulfate.

In another preferred embodiment of the method according to the invention, the water-soluble solids are mineral fertilizers, in particular mixtures of mineral fertilizers.

In particular, according to the method according to the invention, urea, magnesium sulfate, potassium sulfate, sodium sulfate, as well as the following mixtures can be pelletized: (NH₄)₂SO₄-NH₄NO₃, KCl-(NH₄)₂SO₄-NH₄NO₃-ammophos, KCl-(NH₄)₂SO₄-ammophos, KCl-ammophos, KCl-H₃BO₃.

In a preferred embodiment, the range of the commercial fraction of D₁-D₂ corresponds to the condition that 0.5 mm

$$\leq \frac{{D}_{1} + {D}_{2}}{2} \leq 11 mm$$

with D₁≥0.2 mm. In a particularly preferred embodiment, diameter D₁ is in the range of 0.2 mm to 10.0 mm, and the diameter D₂ is in the range of 0.8 mm to 11.8 mm.

In the method according to the invention, water, an aqueous solution of a pelletizing substance, an aqueous solution of a mixture of pelletizing substances, or an aqueous solution of one or more substances other than the pelletizing substance can be used as the aqueous phase.

The method according to the invention can be carried out on standard industrial equipment known to a person skilled in the field of chemical engineering.

In a preferred embodiment, the grinding of the fine fraction, and also, if necessary, of the raw material, is carried out in a vortex mill. Instead of a vortex mill, one can use any other standard grinding equipment known to a person skilled in the art, for example, a tube mill.

According to the invention, the pelletizing step is carried out on a traditional disc pelletizer equipped with an aqueous phase feeding line to irrigate the charge.

In the method according to the invention, the step of drying the resulting pelletized mixture after the pelletizer is preferably carried out in a fluidized bed dryer. Instead of a fluidized bed dryer, one can use any other standard drying equipment, for example a drying drum, but the fluidized bed dryer is chosen based on the economic factor, since it has a significantly higher drying speed.

According to the invention, the step of dividing the dried pelletized product into fractions is carried out by means of a two-step classification on vibrating screens with different numbers of screen levels. At the first step of a two-step classification, a vibrating screen with three levels of sieves is used to divide the dried pelletized charge into a commercial fraction, a coarse fraction, a recycled fraction and a fine fraction; at the second step of a two-step classification, the crushed coarse fraction is divided on a vibrating screen with one level of sieves.

Furthermore, the crushed fine fraction, and, if necessary, the raw material, is classified in a pneumatic classifier before being fed into the pelletizer.

If the raw material before feeding contains a minimum amount of fraction with a particle size of

$$\frac{{D}_{1} + {D}_{2}}{9}$$

to

$$\frac{{D}_{1} + {D}_{2}}{44} ,$$

it can be fed to the pelletizer without grinding and classification. In this case, the ground fine fraction, after classification, is fed into the pelletizer in parallel with the raw material.

However, in a preferred embodiment, the method according to the invention comprises an additional step of crushing and classifying the raw material before feeding it to the pelletizing disc. In a particularly preferred embodiment of the method, the raw material is crushed and classified together with the recycled fine fraction and the resulting combined raw material is fed to the next process step.

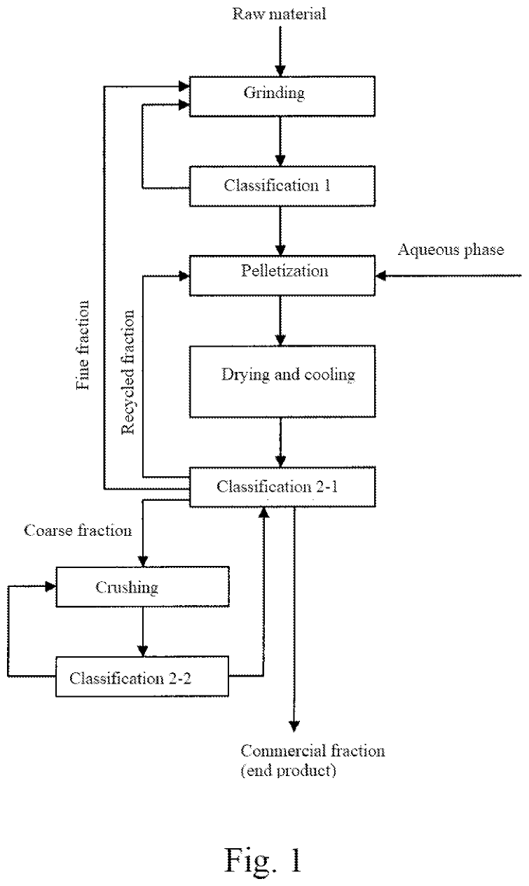

FIG. 1 represents a flow diagram of the process according to the invention, comprising the additional step of grinding and classification of the raw material.

According to this diagram, the method is carried out as follows.

The starting water-soluble solid is fed to a vortex mill, where the fine fraction is also fed after classifying the pelletized charge on a screen. Grinding is carried out in a vortex mill. From the mill, the ground powder enters the gas duct, where the circulating air flow created by the fan is transported to the pneumatic classifier. The pneumatic classifier provides the end division into a fraction with a particle diameter exceeding

$$\frac{{D}_{1} + {D}_{2}}{44} ,$$

which is not suitable for pelletizing, and a fraction with a particle diameter of less than

$$\frac{{D}_{1} + {D}_{2}}{44} ,$$

which is the raw material for a disc pelletizer. The fraction with a particle diameter exceeding

$$\frac{{D}_{1} + {D}_{2}}{44}$$

is poured through a sluice gate into the loading pipe of the vortex mill and sent for re-grinding.

The suitable fraction for pelletizing is transported by air flow to a stack of cyclones, where it is separated from the air and collected in the cyclone hopper. From the hopper, the powder is transported by a screw conveyor to a disc pelletizer. Also, after classification on a screen, the recycled product having a particle size of

$$\frac{{D}_{1} + {D}_{2}}{9}$$

to D₁ is fed into the disc pelletizer. The pelletized charge in the disc pelletizer is irrigated with an aqueous phase.

In the pelletizer, fine particles are fed into the irrigation zone by a scraper. Coarse particles roll over the surface of the disc and, having reached a certain size, are unloaded from it over the side, and fine particles, under the influence of centrifugal force, are fed to the solid components feeding zone and the irrigation zone for further agglomeration and balling.

The stream of wet pellets flows over the side of the disc into an inclined chute lined with a fluoroplastic to prevent sticking of the wet charge and then enters the fluidized bed (FB) dryer.

The drying process occurs due to the heat transferred by steam to the product through a tubular immersion heat exchanger. The plant uses wet steam with a pressure of 10 atm (T=183° C.). The speed of the upward flow in the dryer is maintained by feeding the required volume of air. Air enters the drying zone of the FB dryer at a temperature of 90-140° C.

Pellets are dried in such a way that at the dryer outlet a product is obtained with a temperature of 90-140° C. and with a moisture weight fraction not exceeding 0.5%. The hot product enters the lower fluidized bed of the FB dryer through a vertical valve, where it is cooled by shop air.

The shop air is fed by a fan to the FB dryer through a perforated hearth, cools the product to a temperature of 65-70° C., passes through a heat generator, in which it is heated to a temperature of 90-140° C. and then enters the drying zone of the FB dryer.

The classification of pellets leaving the dryer is carried out on two vibrating screens. The first screen has three levels of sieves. On the first screen, the pellets are divided into four fractions:
coarse fraction having a pellet diameter of >D₂;
commercial fraction having a pellet diameter in the range of D₁ to D₂;
recycled fraction having a pellet diameter in the range of

$$\frac{{D}_{1} + {D}_{2}}{9}$$

### to D₁;

fine fraction having a pellet diameter of

$$< \frac{{D}_{1} + {D}_{2}}{9} .$$

The fine fraction from the screen is fed through pipes to the start of the process for grinding in a vortex mill.

The coarse fraction from the screen is fed to the crusher, where it is crushed into a smaller size. The product crushed in the crusher is fed for screening into a second screen, which has one level of sieves. On the second screen, the crushed pellets are divided into two fractions:
fraction having a pellet diameter of >D₁;
fraction having a pellet diameter of <D₁.

The fraction having a pellet diameter of <D₁ is fed to the first screen for re-screening of the recycled pellets having a size of

$$\frac{{D}_{1} + {D}_{2}}{9}$$

to D₁. The fraction having a pellet diameter of >D₁ after screening is recycled to the crusher for re-crushing. Thus, a closed crusher-screen cycle is formed, which processes coarse pellets into recycled pellets, thereby ensuring the process with a sufficient amount of the recycled product.

The resulting recycled fraction is fed as seed particles to a disc pelletizer.

The commercial fraction is fed, if necessary, to the step of post-treatment of pellets with an anti-caking agent and then to the end product hopper.

The invention is further explained in more detail by means of examples.

### EXAMPLES

### Example 1. Pelletizing Ammonium Sulfate by the Method According to the Invention

The following main devices were used as equipment:
Pallmann PSKM 15-720 vortex mill (500×2400×2400 mm, D=1500 mm, electric motor N=315-500 kW);
Disc pelletizer D=8000 mm, N=600 mm, Q=50 t/h, inclination angle=40-60°, n=2.2-6.6 rpm, AIR 315 54 electric motor, N=160 kW, n=1500 rpm;
12X18N10T fluidized bed dryer, hearth area=9 m²;
Vibrating screen 1, Q=75 t/h, single screen level area S=9 m², three screen levels, two vibration motors N=15 KW, n=960 rpm. Mesh size of sieve levels: top—5.0×5.0 mm, middle—2.0×2.0 mm, bottom—0.8×0.8 mm;
SMD-504 hammer crusher;
Vibrating screen 2, Q=75 t/h, single screen level area S=9 m², one sieve level, two vibration motors N=15 KW, n=960 rpm. Sieve mesh size=2.0×2.0 mm, and
standard auxiliary equipment for transportation, heating and storage that is well known to one skilled in the art.

Ammonium sulfate (TS (technical specifications) 113-03-625-90, produced by «SDS Azot» JSC, Kemerovo city) with a particle size of 0.5 mm to 6 mm was used as the starting material to be pelletized.

### Technological Procedure

32.7 t/h of crystalline ammonium sulfate is fed into a vortex mill (transport volume of about 11 m³), which also receives 5.2 t/h of fine pellets after classification on a screen into a fraction of particles with a size of less than 0.8 mm.

Ammonium sulfate is ground in a vortex mill. The primary classification of the powder is carried out in the vortex mill itself.

From the mill, the ground powder enters the gas duct, in which the circulating air flow created by the fan is transported to the pneumatic classifier. The pneumatic classifier provides the final division into a fraction of more than 0.16 mm, which is not suitable for pelletizing, and a fraction of less than 0.16 mm, which is the raw material for a disc pelletizer. A fraction of more than 0.16 mm (about 3 t/h) is poured through a sluice gate into the loading pipe of a vortex mill for re-grinding.

The suitable powder suitable for pelletizing is fed by air flow into a stack of cyclones, where it is separated from the air and collected in the cyclone hopper. From the hopper, the powder is fed by a screw conveyor in an amount of 37.9 t/h to a disc pelletizer. After classification on the screen, 12.1 t/h of recycled product having a particle size of 0.8 mm to 2.0 mm is also fed into the disc pelletizer. The pelletizing charge is irrigated with water at a flow rate of 4.4 m³/h.

To obtain round and durable ammonium sulfate pellets having a diameter of 2 to 5 mm, a disc pelletizer with a diameter of 8.0 m, a side height of 0.6 m, and a dry matter capacity of 50 t/h was used. The rotation axis inclination angle is 48° to the horizontal. The disc rotation speed 5.9 rpm.

In the irrigation zone, water is sprayed by hydraulic nozzles onto a layer of fine particles. To maintain a high-quality ammonium sulfate pelletizing process, the water flow is fed so that the moisture weight fraction in the charge is in the range of 7 to 9%. The moisture content of the charge is measured continuously by a microwave-type sensor immersed in a layer of pellets in the area of their minimum circulation.

A flow of wet pellets of 54.4 t/h after the pelletizer enters the fluidized (FB) bed dryer.

The drying process occurs due to the heat transferred by steam to the product through a tubular immersion heat exchanger with a heat exchange area of 260 m². The plant uses wet steam at a pressure of 10 atm (183° C.). The steam flow into the tubular heat exchanger is automatically adjusted according to the layer temperature of 120 to 140° C. The required volume of air to maintain an upward flow speed in the dryer of 2.5 m/s is 81,000 physical m³/h. Air at a temperature of 120-140° C. after the heat generator enters the drying zone of the FB dryer through a perforated hearth.

Pellets are dried in such a way that at the dryer outlet a product is obtained having a temperature of 120-140° C. and moisture weight fraction of no more than 0.5%. The hot product enters the lower fluidized bed of the FB dryer through a vertical valve, where it is cooled by shop air.

The shop air is fed by a fan with a capacity of 60,000 m³/h into the FB dryer through a perforated hearth, cools the product to a temperature of 65-70° C., passes through a heat generator, where it is heated to a temperature of 120-140° C., and then enters the drying zone of the FB dryer.

The classification of pellets coming out of the dryer is carried out on two vibrating screens. The first screen has three levels of sieves. The sifting surface area of each level is 9 m². On the first screen, the pellets are divided into four fractions:
coarse fraction having a pellet diameter of more than 5.0 mm;
commercial fraction having a pellet diameter of 2.0 to 5.0 mm;
recycled fraction having a pellet diameter of 0.8 mm to 2.0 mm;
fine fraction having a pellet diameter of less than 0.8 mm.

The fine fraction from the 5.2 t/h screen is fed through pipes for grinding into a vortex mill.

The coarse fraction from the 5 t/h screen is fed to a crusher, where it is crushed into a smaller size.

After the crusher, the ground product is sent for sieving into a second screen, which has one level of sieves with a sieving surface area of 9 m².

On the second screen, the crushed pellets are scattered into two fractions:
fraction having a particle diameter of more than 2.0 mm;
fraction having a particle diameter of less than 2.0 mm.

The fraction having a particle diameter of less than 2.0 mm is fed to the first screen for re-screening of the recycled pellets having size in the range of 0.8 mm to 2 mm. The fraction having a particle diameter of more than 2 mm after screening is recycled to the crusher for re-crushing. Thus, a closed crusher-screen cycle is formed, which processes coarse pellets into recycled pellets, thereby ensuring the process in a with a sufficient amount of the recycled product.

The recycled fraction of 12.1 t/h is fed as seed particles to a disc pelletizer.

The commercial fraction of 32.7 t/h is fed to the step of post-treatment of pellets with an anti-caking agent and then to the end product hopper.

Table 1 represents the main parameters for obtaining pelletized ammonium sulfate within 36 hours when pelletization uses the classified powder containing 100% fraction having the particle size of less than 0.16 mm.

As can be seen from Table 1, this method provides almost 100% aggregation of the starting ammonium sulfate powder into commercial pellets having a diameter of 2 mm (D₁) to 5 mm (D₂) during the entire period of feeding the raw materials.

TABLE 1

| Time from | | | Load on disc for raw charge, t/h | | | | | | |
|---|---|---|---|---|---|---|---|---|---|
| the start of | Load on the | Water | | including | Particle size distribution of the product, % | | | | Yield of the |
| parameter | mill for raw | consumption, | | recycled | Coarse | Commercial | Recycled | Fine | end product²⁾, |
| measurements, h | materials¹⁾, t/h | m³/h | Total | product | >5 mm | 2-5 mm | 0.8-2 mm | <0.8 mm | % |
| 0 | 37.4 | 4.7 | 49.7 | 12.3 | 2.6 | 64.8 | 22.7 | 9.9 | 86.1 (100)³⁾ |
| 2 | 37.6 | 4.5 | 50.0 | 12.5 | 2.4 | 64.6 | 22.5 | 10.5 | 86.0 (100) |
| 4 | 37.9 | 4.3 | 51.5 | 13.6 | 2.2 | 63.6 | 24.4 | 9.8 | 86.4 (100) |
| 6 | 37.8 | 4.1 | 52.7 | 14.8 | 2.0 | 62.1 | 26.4 | 9.5 | 86.4 (100) |
| 8 | 38.3 | 4.3 | 53.0 | 14.7 | 2.0 | 62.1 | 26.2 | 9.7 | 86.0 (100) |
| 10 | 36.4 | 4.8 | 48.3 | 11.8 | 2.5 | 64.8 | 23.0 | 9.7 | 85.9 (100) |
| 12 | 37.9 | 4.4 | 48.7 | 10.7 | 2.1 | 66.3 | 22.0 | 9.6 | 85.0 (100) |
| 14 | 37.5 | 4.8 | 48.8 | 11.3 | 2.0 | 65.0 | 22.8 | 10.2 | 84.6 (100) |
| 16 | 37.9 | 4.7 | 50.1 | 12.2 | 2.6 | 63.7 | 23.3 | 10.4 | 84.1 (100) |
| 18 | 37.5 | 4.4 | 49.7 | 12.2 | 2.4 | 65.0 | 23.0 | 9.6 | 86.1 (100) |
| 20 | 37.9 | 4.3 | 51.1 | 13.3 | 2.2 | 63.7 | 24.0 | 10.1 | 86.1 (100) |
| 22 | 38.8 | 4.0 | 49.8 | 11.0 | 1.8 | 66.2 | 22.1 | 9.9 | 85.0 (100) |
| 24 | 38.4 | 4.1 | 49.8 | 11.4 | 2.0 | 65.4 | 22.6 | 10.0 | 84.9 (100) |
| 26 | 38.3 | 4.3 | 49.2 | 10.9 | 1.6 | 66.0 | 22.2 | 10.2 | 84.8 (100) |
| 28 | 38.4 | 4.4 | 49.4 | 11.0 | 2.1 | 65.7 | 22.3 | 9.9 | 84.6 (100) |
| 30 | 38.3 | 4.3 | 49.6 | 11.3 | 2.0 | 65.5 | 22.0 | 10.5 | 84.9 (100) |
| 32 | 38.3 | 4.4 | 50.5 | 12.2 | 2.5 | 65.1 | 22.1 | 10.3 | 85.8 (100) |
| 34 | 38.2 | 4.4 | 50.6 | 12.4 | 2.1 | 65.3 | 22.4 | 10.2 | 86.4 (100) |
| 36 | 37.6 | 4.3 | 48.3 | 10.6 | 1.9 | 66.0 | 22.0 | 10.1 | 84.6 (100) |
| Mean value | 37.9 | 4.4 | 50.0 | 12.1 | 2.2 | 64.8 | 23.1 | 10.0 | 85.5 (100) |
| Standard | 0.51 | 0.22 | 1.31 | 1.24 | 0.28 | 1.24 | 1.32 | 0.31 | 0.75 |
| deviation | | | | | | | | | |

¹⁾The load on the mill for raw materials comprises the consumption of starting ammonium sulfate of 32.7 ± 0.5 t/h and screenings (<0.8 mm) of 5.2 ± 0.1 t/h.
²⁾The yield of the end product is calculated relative to the load on the mill.
³⁾The yield of the end product based on the consumption of starting ammonium sulfate without taking into account technological losses

### Example 2 (Comparative). Pelletizing Ammonium Sulfate Without Partial Removal of the Fine Fraction

Pelletization was carried out on the same equipment as in example 1.

Ammonium sulfate (grade B according to TS (technical specifications) 113-03-625-90, produced by «SDS Azot» JSC, Kemerovo city) having a particle size of 0.5 mm to 6 mm was used as the starting material for pelletization.

### Technological Procedure

10.0 t/h of crystalline ammonium sulfate is fed by an elevator to a receiving hopper with a volume of 40 m₃. From the receiving hopper, ammonium sulfate is fed to a belt-conveyer scale and then fed by a screw conveyor to a vortex mill.

Ammonium sulfate is ground in a vortex mill. The fraction having a particle size exceeding 0.16 mm in the output ammonium sulfate ranges from 6 to 10%.

From the mill, the ground powder is fed by means of an elevator and a belt conveyor to the feed hopper of a disc pelletizer, where fine pellets are also fed after classification on a screen. The mixed product in an amount of 11 to 20 t/h from the feeding hopper is fed by a sluice dispenser into a disc pelletizer. Further, the recycled pellets are fed as seed particles into the disc pelletizer from the recycled product hopper using a sluice dispenser in an amount of 2 to 8 t/h in proportion to the flow rate of the mixed product from the feeding hopper. In the pelletizer, the mixture of powder and recycled product is irrigated with water at a flow rate of 1.0 to 2.2 m³/h.

To obtain round and durable ammonium sulfate pellets having a diameter of 2 to 5 mm, a disc pelletizer with a diameter of 8.0 m, a side height of 0.6 m, and a dry matter capacity of 50 t/h was used. The rotation axis inclination angle is 48° to the horizontal. The disc rotation speed is 5.9 rpm.

In the irrigation zone, water is sprayed by hydraulic nozzles onto a layer of fine particles. To maintain a high-quality ammonium sulfate pelletizing process, water consumption is set so that the moisture weight fraction in the charge is in the range of 7 to 9%. The moisture content of the charge is measured in continuous mode by a microwave-type sensor immersed in a layer of pellets in the area of their minimum circulation.

The flow of wet pellets after the pelletizer enters the fluidized bed (FB) dryer.

Pellets are dried in such a way that at the dryer outlet the resulting product has a temperature of 120-140° C. and moisture weight fraction of moisture of no more than 0.5%. The hot product enters the lower fluidized bed of the FB dryer through a vertical valve, where it is cooled by shop air.

The classification of pellets leaving the dryer is carried out on two vibrating screens. The first screen has three levels of sieves. The sifting surface area of each level is 9 m². On the first screen, the pellets are divided into four fractions:
coarse fraction having a pellet size of more than 5.0 mm;
commercial fraction having a pellet size of from 2.0 to 5.0 mm;
recycled fraction having a pellet size of 0.8 mm to 2.0 mm;
fine fraction having a pellet size of less than 0.8 mm.

The fine fraction in an amount of no more than 10 t/h from the screen is fed by gravity through pipes to the supply hopper of the disc pelletizer, and an excess of the fine fraction of 5 t/h is removed from the circulation circuit into the storage hopper.

The coarse fraction in an amount of 1-4 t/h is fed by gravity from the screen through pipes to a crusher, where it is crushed into a finer size. After the crusher, the ground product is fed for screening into a second screen, which has one level of sieves with a screening surface area of 9 m². On the second screen, the crushed pellets are divided into two fractions:
fraction having a particle diameter of more than 2.0 mm;
fraction having a particle diameter of less than 2.0 mm.

The fraction having a particle diameter of less than 2.0 mm is fed to the first screen for re-screening of recycled pellets ranging in size from 0.8 mm to 2 mm. The fraction having a particle diameter of more than 2 mm after screening is recycled to the crusher for re-crushing.

The recycled fraction of 2-8 t/h is fed to the recycled product hopper of a disc pelletizer and is used as a seed when pelletizing fine particles.

The commercial fraction is fed to the step of post-treatment of pellets with an anti-caking agent and then to the end product hopper.

Table 2 represents the main parameters for obtaining pelletized ammonium sulfate within 12 hours by this method.

TABLE 2

| Time from | Ammonium | | | | | | | | | | Fine |
|---|---|---|---|---|---|---|---|---|---|---|---|
| the start | sulfate | Water | Load on disc for raw mixture, t/h | | | | | | | Yield of | screenings |
| of parameter | consumption | con- | | including fraction | | Particle size distribution of the product, % | | | | commercial | into the |
| measure- | on mill, | sumption, | | 0.8-2 mm | less than | Coarse | Commercial | Recycled | Fine | product, | storage |
| ments, h | t/h | m³/h | Total | (recycled) | 0.8 mm | >5 mm | 2-5 mm | 0.8-2 mm | <0.8 mm | % | hopper, t/h |
| 0 | 10.0 | 1.0 | 12.6 | 1.6 | 1.0 | 8.4 | 32.2 | 12.7 | 46.7 | 40.6 | 0.0 |
| 2 | 10.0 | 1.5 | 18.5 | 2.1 | 6.4 | 17.0 | 26.4 | 11.5 | 45.1 | 49.0 | 5.0 |
| 4 | 10.0 | 1.9 | 23.6 | 3.7 | 9.9 | 15.0 | 17.8 | 15.7 | 51.6 | 42.0 | 5.0 |
| 6 | 10.0 | 2.0 | 24.4 | 5.5 | 9.0 | 8.9 | 18.8 | 22.4 | 49.9 | 46.0 | 5.0 |
| 8 | 10.0 | 2.0 | 24.8 | 6.6 | 8.3 | 10.2 | 14.5 | 26.4 | 48.9 | 35.9 | 5.0 |
| 10 | 10.0 | 2.1 | 26.3 | 7.8 | 8.4 | 12.3 | 15.6 | 29.8 | 42.2 | 41.0 | 5.0 |
| 12 | 10.0 | 2.2 | 27.2 | 7.8 | 9.3 | 6.8 | 12.4 | 28.8 | 51.9 | 33.8 | 5.0 |

Mean static strength of pellets - 2.7 MPa

TABLE 3

| | | | Load on disc for | | | | | | |
|---|---|---|---|---|---|---|---|---|---|
| Time from | Mill load | | raw mixture, t/h | | | | | | |
| the start of | for raw | Water | | including | Particle size distribution of the product, % | | | | |
| parameter | materials¹⁾ | consumption, | | recycled | Coarse | Commercial | Recycled | Fine | Yield of end |
| measurements, h | t/h | m³/h | Total | product | >5 mm | 2-5 mm | 0.8-2 mm | <0.8 mm | product²⁾, % |
| 0 | 32.5 | 3.5 | 36.7 | 4.2 | 0.6 | 86.6 | 11.2 | 1.6 | 97.9 3) |
| 2 | 32.8 | 3.5 | 36.8 | 3.9 | 0.4 | 86.3 | 10.5 | 2.8 | 96.8 |
| 4 | 32.6 | 3.5 | 36.9 | 4.1 | 0.8 | 86.2 | 11.0 | 2.0 | 97.7 |
| 6 | 32.7 | 3.5 | 37.4 | 4.6 | 0.4 | 85.0 | 12.3 | 2.3 | 97.3 |
| 8 | 32.5 | 3.5 | 36.8 | 4.2 | 0.6 | 86.3 | 11.3 | 1.8 | 97.9 |
| 10 | 32.6 | 3.5 | 36.8 | 4.0 | 0.7 | 86.3 | 10.8 | 2.2 | 97.5 |
| 12 | 32.5 | 3.5 | 36.8 | 4.1 | 0.5 | 86.4 | 11.2 | 1.9 | 97.8 |

Mean static strength of pellets - 3.9 MPa
¹⁾The load on the mill for raw materials comprises the consumption of starting potassium sulfate of 31.8 t/h and screenings (<0.8 mm) of 0.8 t/h.
²⁾The end product yield is calculat ed relative to the load on the mill.
3) The end product yield from the consumption of the starting potassium sulfate without taking into account technological losses is 100%.

Under these process conditions, it was impossible to increase the load on the disc for the raw mixture to more than 27 t/h, since at values greater than 27 t/h there was practically no commercial fraction.

Due to the fact that during the pelletizing process an amount of the fine fraction (finer than 0.8 mm) accumulates, and the load on the disc of the raw mixture cannot be increased above 27 t/h, then from a certain point in time it is necessary to remove a part of the fine fraction (finer than 0.8 mm) into a storage hopper. Since the volume of this hopper is limited, the process had to be stopped after 12 hours.

As can be seen from Table 2, when ammonium sulfate powder containing from 6 to 10% of particles having a size greater than 0.16 mm is used for pelletizing, and the fraction from 0.16 to 0.8 mm is not removed, the particle size distribution of the product leaving the disc is extremely heterogeneous. The content of coarse pellets having a size of greater than 5 mm is on average 4.5 times higher than that in Example 1. The content of the commercial fraction having a size of 2-5 mm is on average 1.8 times lower.

Under conditions of automatic maintenance of the charge humidity from 7 to 9%, the pelletizing process is random: either coarse pellets are balled, or a non-pelletized product is poured from the disc. The end product yield is also unstable and does not exceed 50% in terms of ammonium sulfate consumption in the mill.

### Example 3. Pelletizing Potassium Sulfate by the Method According to the Invention

Pelletizing was carried out using the equipment and method specified in Example 1.

Crystalline potassium sulfate (TS (technical specifications) 2184-093-43399406-2001), consisting of particles ranging in size from 0.5 mm to 6 mm, was used as the starting material to be pelletized.

To obtain round and strong pellets of potassium sulfate having a diameter of 2 to 5 mm, a disc pelletizer with a diameter of 8.0 m, a side height of 0.6 m, and a dry matter capacity of 50 t/h was used. The rotation axis inclination angle is 48° to the horizontal. The disc rotation speed is 5.9 rpm. The pelletized mixture was irrigated with water at a flow rate of 3.5 m³/h.

The resulting pelletized product was divided into four fractions:
coarse fraction having a particle size of more than 5.0 mm;
commercial fraction having a particle size of 2.0 to 5.0 mm;
recycled fraction having a particle size of 0.8 mm to 2.0 mm;
fine fraction having a particle size of less than 0.8 mm.

Table 3 represents the main parameters and results of obtaining pelletized potassium sulfate.

### Example 4. Pelletizing Urea by the Method According to the Invention

Pelletizing was carried out using the equipment and method specified in Example 1.

Crystalline urea (grade A according to GOST (Russian national standard) 2081-2010), consisting of particles ranging in size of 0.5 mm to 2 mm, and urea-formaldehyde concentrate (UFC-85 according to TS (technical specifications) 2223-009-00206492-07) were used as the starting materials to be pelletized.

To obtain round and strong urea pellets with a diameter of 6 to 8 mm, a disc pelletizer with a diameter of 8.0 m, a side height of 0.6 m, and a dry substance capacity of 50 t/h was used. The rotation axis inclination angle is 40° to the horizontal. The disc rotation speed is 3.5 rpm. The pelletized charge was irrigated with a pelletizing solution of 3.4-4.0 t/h containing 45-50% urea and 4.0-4.4% UFC-85.

To carry out drying in a fluidized bed dryer, air with a temperature of 90-5-100° C. was used.

The resulting pelletized product was divided into four fractions:
coarse fraction having a particle size of more than 8.0 mm;
commercial fraction having a particle size of 6.0 to 8.0 mm;
recycled fraction having a particle size of 1.6 mm to 6.0 mm;
fine fraction having a particle size of less than 1.6 mm.

Table 4 represents the main parameters and results of obtaining pelletized urea.

TABLE 4

| | | | | | | Load on disc for | | | | | | |
|---|---|---|---|---|---|---|---|---|---|---|---|---|
| | Load of raw material | | | | | raw mixture, t/h | | | | | | |
| Time from | on mill, t/h | | Consumption of | | | | including | | | | | |
| the start of | | Including | pelletizing solution, t/h | | | | fraction | Particle size distribution of the product, % | | | | Yield of |
| parameter | | fraction | | Including | | | of 1.6-6 mm | Coarse | Commercial | Recycled | Fine | end |
| measurements, h | Total | of <1.6 mm | Total | Urea | UFC-85 | Total | (recycled) | >8 mm | 6-8 mm | 1.6-6 mm | <1.6 mm | product, % |
| 0 | 17.4 | 2.1 | 3.5 | 1.6 | 0.2 | 21.3 | 3.9 | 1.6 | 73.3 | 16.7 | 8.3 | 88.1 |
| 2 | 17.6 | 2.3 | 3.6 | 1.7 | 0.2 | 21.5 | 3.9 | 1.5 | 72.9 | 16.6 | 9.0 | 87.4 |
| 4 | 17.9 | 2.2 | 3.7 | 1.7 | 0.2 | 22.4 | 4.5 | 1.4 | 71.4 | 18.6 | 8.6 | 87.8 |
| 6 | 17.8 | 2.6 | 3.8 | 1.8 | 0.2 | 22.7 | 4.9 | 1.2 | 68.7 | 20.0 | 10.0 | 85.9 |
| 8 | 18.3 | 2.3 | 3.8 | 1.8 | 0.2 | 23.2 | 4.9 | 1.2 | 70.9 | 19.4 | 8.5 | 87.9 |
| 10 | 16.4 | 2.3 | 3.4 | 1.6 | 0.2 | 20.5 | 4.1 | 1.6 | 70.6 | 18.3 | 9.6 | 86.4 |
| 12 | 17.9 | 2.4 | 3.8 | 1.8 | 0.2 | 22.7 | 4.8 | 1.3 | 70.2 | 19.3 | 9.2 | 87.0 |
| 14 | 17.5 | 2.3 | 3.7 | 1.7 | 0.2 | 22.3 | 4.8 | 1.2 | 70.0 | 19.8 | 9.0 | 87.2 |
| 16 | 17.9 | 2.2 | 3.6 | 1.7 | 0.2 | 21.9 | 4.0 | 1.6 | 73.0 | 16.8 | 8.6 | 87.7 |
| 18 | 17.5 | 2.5 | 3.6 | 1.7 | 0.2 | 21.9 | 4.4 | 1.5 | 70.3 | 18.4 | 9.8 | 86.2 |
| 20 | 17.9 | 2.6 | 3.8 | 1.7 | 0.2 | 22.6 | 4.7 | 1.4 | 69.3 | 19.2 | 10.1 | 85.8 |
| 22 | 18.8 | 2.1 | 4.0 | 1.9 | 0.2 | 24.0 | 5.2 | 1.1 | 71.4 | 19.8 | 7.6 | 89.1 |
| 24 | 18.4 | 2.3 | 3.9 | 1.8 | 0.2 | 23.3 | 4.9 | 1.2 | 70.5 | 19.5 | 8.8 | 87.5 |
| 26 | 18.3 | 2.2 | 3.9 | 1.8 | 0.2 | 23.8 | 5.5 | 1.0 | 69.5 | 21.2 | 8.3 | 88.2 |
| 28 | 18.4 | 2.1 | 3.8 | 1.8 | 0.2 | 23.1 | 4.7 | 1.3 | 72.1 | 18.6 | 8.0 | 88.6 |
| 30 | 18.3 | 2.3 | 3.9 | 1.8 | 0.2 | 23.2 | 4.9 | 1.2 | 70.5 | 19.5 | 8.8 | 87.5 |
| 32 | 18.3 | 2.7 | 3.8 | 1.8 | 0.2 | 22.8 | 4.5 | 1.6 | 70.1 | 18.0 | 10.3 | 85.5 |
| 34 | 18.2 | 2.1 | 3.8 | 1.8 | 0.2 | 22.8 | 4.6 | 1.3 | 72.1 | 18.7 | 7.9 | 88.7 |
| 36 | 18.6 | 2.3 | 3.9 | 1.8 | 0.2 | 23.7 | 5.1 | 1.2 | 70.4 | 19.8 | 8.6 | 87.8 |

Mean static strength of pellets - 3.1 MPa
¹⁾ The end product yield is calculated relative to the load on the mill.
²⁾ The end product yield from the total consumption of urea (excluding UFC-85) without taking into account technological losses is 100%.

The results presented in Examples 3-4 show that the method according to the invention can be implemented for a wide range of different water-soluble solids and to obtain different particle size distributions while maintaining process stability.

1. A method for continuously pelletizing water-soluble solids, comprising steps of:
a) feeding raw material and seed particles to a pelletizing disc;
b) pelletizing water-soluble solids during wetting with an aqueous phase;
c) removing pelletized product from the pelletizing disc;
d) drying the pelletized product from step c);
e) dividing the dried pelletized product from step d) into fractions;
f) removing the commercial fraction from the process;
characterized in that in step e), the dried pelletized product from step d) is divided into four fractions:
a commercial fraction having a pellet diameter in the range of D₁ to D₂;
a coarse fraction having a pellet diameter>D₂;
a recycled fraction having a pellet diameter in the range of
$$\frac{{D}_{1} + {D}_{2}}{9}$$
to D₁;
a fine fraction having a pellet diameter in the range of
$$< \frac{{D}_{1} + {D}_{2}}{9} ;$$
wherein the recycled fraction is fed as the seed particles to the raw material feeding step a), the coarse fraction is fed for grinding to a particle diameter in the range of
$$\frac{{D}_{1} + {D}_{2}}{9}$$
to D₁ and then recycled to the process at the raw material feeding step a), the fine fraction is fed for grinding until there are no pellets having the size exceeding the particle size of the raw material, and also recycled to the raw material feeding step a), wherein the raw material particle diameter is
$$\frac{{D}_{1} + {D}_{2}}{9}$$

2. The method according to claim 1, further comprising an additional step of crushing and classifying the raw material before feeding it to the pelletizing disc.

3. The method according to claim 2, wherein the crushing and classification of the raw material is carried out together with the recycling fine fraction, and the resulting combined raw material is fed to the next step of the method.

4. The method according to claim 1, wherein the water-soluble solids are mineral salts.

5. The method according to claim 4, wherein the water-soluble solids are sodium, potassium or ammonium nitrates, sulfates or chlorides.

6. The method according to claim 5, wherein the water-soluble solid is ammonium sulfate.

7. The method according to claim 1, wherein the water-soluble solids are mineral fertilizers, in particular, mixtures of mineral fertilizers.

8. The method according to claim 1, wherein the range of the commercial fraction D₁-D₂ corresponds to the condition that
$$0.5 mm \leq \frac{{D}_{1} + {D}_{2}}{2} \leq 11 mm ,$$
wherein D₁≥0.2 mm.
